(19) United States
(12) Patent Application Publication
(10) Pub. No.: US 2024/0233048 A9
(43) Pub. Date: Jul. 11, 2024

(54) CONSTRUCTION MANAGEMENT SYSTEM, DATA PROCESSING DEVICE, AND CONSTRUCTION MANAGEMENT METHOD

(71) Applicant: Komatsu Ltd., Tokyo (JP)

(72) Inventors: Shun Kawamoto, Tokyo (JP); Tsubasa Hasumi, Tokyo (JP); Minami Sugimura, Tokyo (JP); Li Dong, Tokyo (JP); Shota Hirama, Tokyo (JP)

(73) Assignee: Komatsu Ltd., Tokyo (JP)

(21) Appl. No.: 18/278,465

(22) PCT Filed: Feb. 22, 2022
(86) PCT No.: PCT/JP2022/007307

§ 371 Date: Aug. 23, 2023

(30) Foreign Application Priority Data
Mar. 31, 2021 (JP) 2021-061691

(51) Int. Cl. G06Q 50/08; G06T 17/00; G06V 20/17; G06V 40/10

(52) U.S. Cl. CPC G06Q 50/08; G06T 17/00; G06V 20/17; G06V 40/10; G06V 2201/08

(57) ABSTRACT

A construction management system includes a current terrain data creation unit that creates current terrain data of a construction site on which a work machine operates, a detection data acquisition unit that acquires detection data of a detection device that detects the construction site, a reflection unit that generates reflection data in which the detection data is reflected in the current terrain data, and an output unit that outputs the reflection data on a display device.

### FIELD

The present disclosure relates to a construction management system, a data processing device, and a construction management method.

### BACKGROUND

In a technical field related to construction management systems, there is known a construction management system as disclosed in Patent Literature 1.

### CITATION LIST

### Patent Literature

Patent Literature 1: WO 2019/012993 A

### SUMMARY

### Technical Problem

In order to suppress a reduction in construction efficiency on a construction site, it is preferable to appropriately confirm the progress of construction.

An object of the present disclosure is to confirm the progress of construction.

### Solution to Problem

According to an aspect of the present invention, a construction management system comprises: a current terrain data creation unit that creates current terrain data of a construction site on which a work machine operates; a detection data acquisition unit that acquires detection data of a detection device that detects the construction site; a reflection unit that generates reflection data in which the detection data is reflected in the current terrain data; and an output unit that outputs the reflection data on a display device.

### Advantageous Effects of Invention

According to the present disclosure, it is possible to confirm the progress of construction.

### BRIEF DESCRIPTION OF DRAWINGS

FIG. 1 is a schematic diagram illustrating a construction management system according to an embodiment.

FIG. 2 is a perspective view of an excavator according to an embodiment.

FIG. 3 is a perspective view illustrating a crawler carrier according to an embodiment.

FIG. 4 is a functional block diagram illustrating the construction management system according to the embodiment.

FIG. 5 is a flowchart illustrating a construction management method according to an embodiment.

FIG. 6 is a diagram illustrating current terrain data according to an embodiment.

FIG. 7 is a diagram illustrating reflection data according to an embodiment.

FIG. 8 is a diagram illustrating the reflection data according to an embodiment.

FIG. 9 is a diagram illustrating the reflection data according to an embodiment.

FIG. 10 is a diagram illustrating the reflection data according to an embodiment.

FIG. 11 is a diagram illustrating the reflection data according to an embodiment.

FIG. 12 is a diagram illustrating the reflection data according to an embodiment.

FIG. 13 is a block diagram illustrating a computer system according to an embodiment.

### DESCRIPTION OF EMBODIMENTS

Embodiments according to the present disclosure will be described below with reference to the drawings, but the present disclosure is not limited to the embodiments. The component elements of the embodiments described below is configured to be appropriately combined with each other. Furthermore, some of the component elements may not be used.

[Construction Management System]

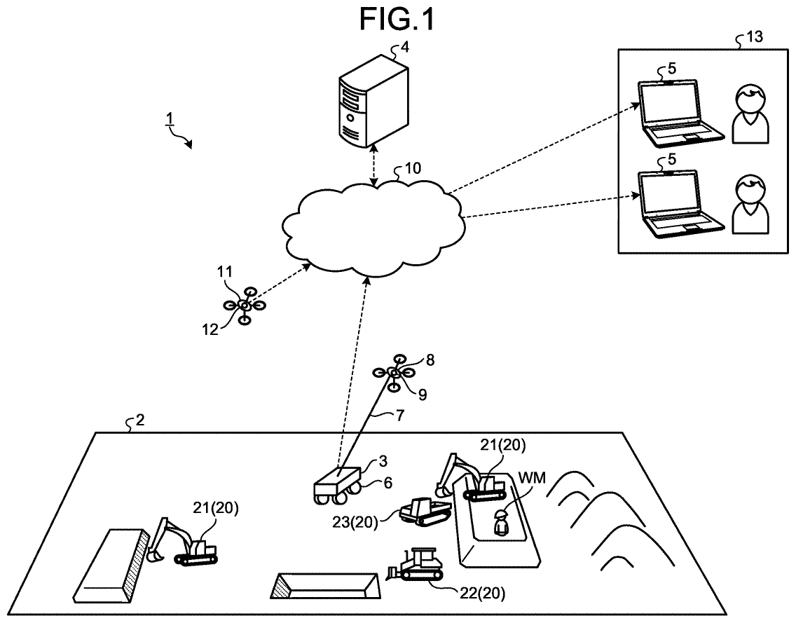

FIG. 1 is a schematic diagram illustrating a construction management system 1 according to an embodiment. The construction management system 1 manages construction on a construction site 2. A plurality of work machines 20 operates on the construction site 2. In the embodiment, the work machines 20 include an excavator 21, a bulldozer 22, and a crawler carrier 23. Note that the work machines 20 may include a wheel loader. In addition, a person WM is on the construction site 2. An example of the person WM includes a worker who works on the construction site 2. Note that the person WM may be a supervisor who manages the construction. The person WM may be a visitor.

As illustrated in FIG. 1, the construction management system 1 includes a management device 3, a server 4, information terminals 5, a detection device 9, and a detection device 12.

The management device 3 includes a computer system arranged on the construction site 2. The management device 3 is supported by a carrier 6. The management device 3 is configured to travel on the construction site 2 by using the carrier 6. Examples of the carrier 6 include an aerial work vehicle, a truck, and a mobile robot. The server 4 is a data processing device including a computer system. The server 4 may be arranged on the construction site 2 or may be arranged at a remote place from the construction site 2. Each of the information terminal 5 is a computer system arranged at a remote place 13 from the construction site 2. An example of the information terminal 5 includes a personal computer or smartphone. The management device 3, the server 4, and the information terminal 5 communicate with each other via a communication system 10. Examples of the communication system 10 include the Internet, a local area network (LAN), a mobile phone communication network, and a satellite communication network.

The detection device 9 detects the construction site 2. The detection device 9 acquires three-dimensional data of the construction site 2. Examples of a detection target to be detected by the detection device 9 include the terrain of the construction site 2 and an object being on the construction site 2. The object includes one or both of a movable body and a stationary body. Examples of the movable body include each of the work machines 20 and the person WM. Examples of the stationary body include lumbers or construction materials.

The three-dimensional data acquired by the detection device 9 includes image data of the construction site 2. The image data acquired by the detection device 9 may be moving image data or still image data. An example of the detection device 9 includes a stereo camera. Note that the detection device 9 may include a monocular camera and a three-dimensional measurement device. An example of the three-dimensional measurement device includes a laser sensor (light detection and ranging: LIDAR) that detects the detection target by emitting a laser beam. Note that the three-dimensional measurement device may be an infrared sensor that detects the object by emitting infrared light, or a radar sensor (radio detection and ranging: RADAR) that detects the object by emitting a radio wave.

The detection device 9 is mounted on a flight vehicle 8. An example of the flight vehicle 8 includes an unmanned aerial vehicle (UAV) such as a drone. The detection device 9 detects the construction site 2 from above the construction site 2.

In the embodiment, the flight vehicle 8 and the management device 3 are connected by a cable 7. Detection data from the detection device 9 is transmitted to the management device 3 via the cable 7. The detection data from the detection device 9 transmitted to the management device 3 is transmitted to the server 4 via the communication system 10.

In the embodiment, the management device 3 includes a power supply or a power generator. The management device 3 is configured to supply power to the flight vehicle 8 via the cable 7.

The detection device 12 detects the construction site 2. Similarly to the detection device 9, the detection device 12 acquires the three-dimensional data of the construction site 2. The three-dimensional data acquired by the detection device 12 includes the image data of the construction site 2.

The detection device 12 is mounted on a flight vehicle 11. The detection device 12 detects the construction site 2 from above the construction site 2. Detection data from the detection device 12 is transmitted to the server 4 via the communication system 10.

The flight vehicle 11 is configured to fly above the flight vehicle 8. The flight vehicle 11 is configured to fly over a wider range than the flight vehicle 8. The detection device 12 is configured to detect a wider range of the construction site 2 than the detection device 9. In the embodiment, the detection device 12 detects the whole of the construction site 2. The detection device 9 detects part of the construction site 2.

[Work Machine]

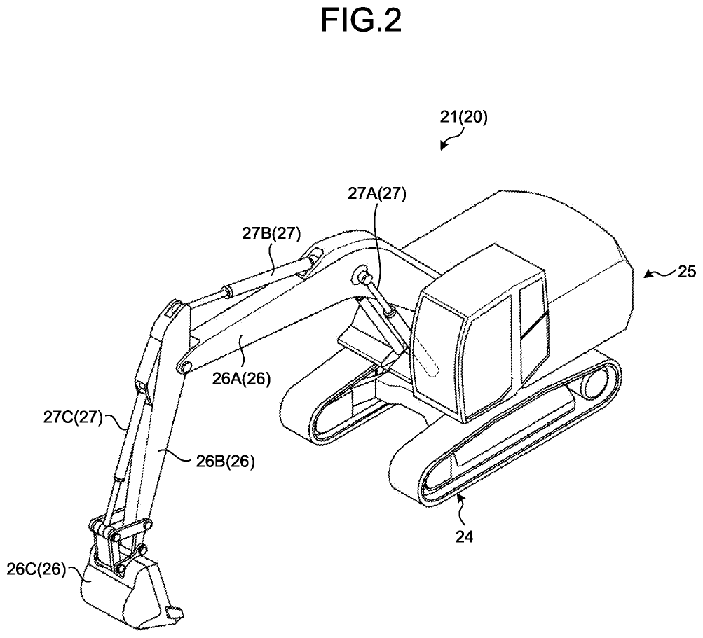

FIG. 2 is a perspective view of the excavator 21 according to an embodiment. As illustrated in FIG. 2, the excavator 21 includes a carriage 24, a swing body 25 that is supported by the carriage 24, working equipment 26 that is supported by the swing body 25, and hydraulic cylinders 27 that drive the working equipment 26.

The carriage 24 has a pair of crawler tracks. The excavator 21 is configured to travel on the construction site 2 by using the carriage 24. The swing body 25 swings while being supported by the carriage 24. The working equipment 26 includes a boom 26A that is connected to the swing body 25, an arm 26B that is connected to the boom 26A, and a bucket 26C that is connected to the arm 26B. The hydraulic cylinder 27 includes a boom cylinder 27A that operates the boom 26A, an arm cylinder 27B that operates the arm 26B, and a bucket cylinder 27C that operates the bucket 26C.

The excavator 21 makes movements. Examples of the movements of the excavator 21 include a traveling movement of the carriage 24, a turning movement of the swing body 25, rising and lowering movements of the boom 26A, excavation and dumping movements of the arm 26B, and excavation and dumping movements of the bucket 26C.

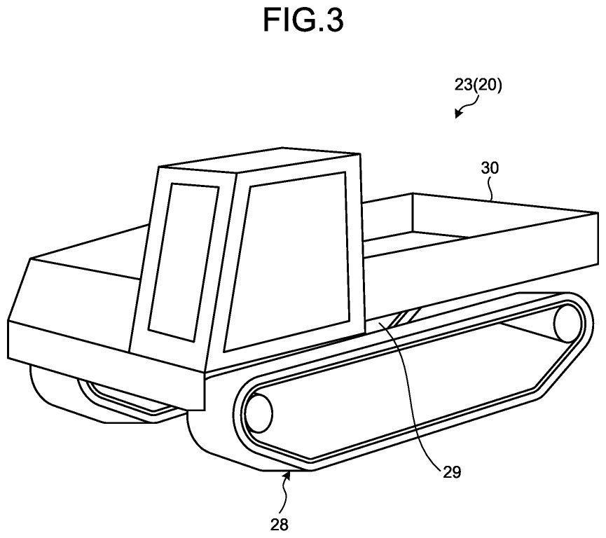

FIG. 3 is a perspective view illustrating a crawler carrier 23 according to an embodiment. As illustrated in FIG. 3, the crawler carrier 23 includes a carriage 28, a vehicle body 29, and a dump body 30.

The carriage 28 has a pair of crawler tracks. The crawler carrier 23 is configured to travel on the construction site 2 by using the carriage 28. The dump body 30 is a member to be loaded. The excavator 21 is configured to load the dump body 30 by using the working equipment 26. The dump body 30 is configured to rise by a hoist cylinder which is not illustrated to discharge the load.

The crawler carrier 23 makes movements. Examples of the movements of the crawler carrier 23 include a traveling movement of the carriage 28 and lowering and dumping movements of the dump body 30.

[Server]

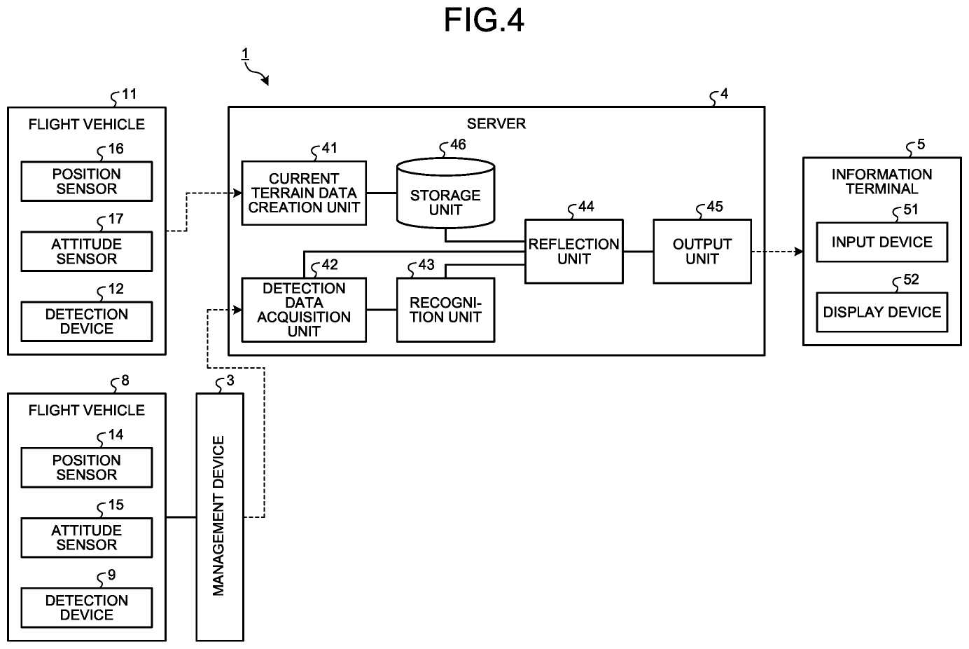

FIG. 4 is a functional block diagram illustrating the construction management system 1 according to an embodiment. As illustrated in FIG. 4, the construction management system 1 includes the flight vehicle 8, the flight vehicle 11, the management device 3 that is arranged on the construction site 2, the server 4, and the information terminal 5 that is arranged at the remote place 13 from the construction site 2.

The flight vehicle 8 includes a position sensor 14, an attitude sensor 15, and the detection device 9.

The position sensor 14 detects the position of the flight vehicle 8. The position sensor 14 detects the position of the flight vehicle 8 by using a global navigation satellite system (GNSS). The position sensor 14 includes a GNSS receiver (GNSS sensor), and detects the position of the flight vehicle 8 in a global coordinate system. The attitude sensor 15 detects an attitude of the flight vehicle 8. An example of the attitude sensor 15 includes an inertial measurement unit (IMU).

The flight vehicle 11 includes a position sensor 16, an attitude sensor 17, and the detection device 12.

The position sensor 16 includes a GNSS receiver and detects the position of the flight vehicle 11 in the global coordinate system. The attitude sensor 17 detects an attitude of the flight vehicle 11. An example of the attitude sensor 17 includes an inertial measurement unit (IMU).

The server 4 includes a current terrain data creation unit 41, a detection data acquisition unit 42, a recognition unit 43, a reflection unit 44, an output unit 45, and a storage unit 46.

The current terrain data creation unit 41 creates current terrain data that indicates a current terrain of the construction site 2 on which the work machines 20 perform operations. The current terrain data is three-dimensional terrain data that indicates the current terrain of the construction site 2. The current terrain includes a reference terrain before predetermined construction is started.

The current terrain data creation unit 41 creates the current terrain data on the basis of the detection data from the detection device 12. As described above, the detection device 12 detects the whole of the construction site 2. The current terrain data indicates the current terrain of the whole of the construction site 2.

In the embodiment, the detection device 12 detects the construction site 2 at a first frequency. For example, the detection device 12 detects the construction site 2 only once before starting the work of the day. The detection device 12 detects the current terrain indicating the reference terrain before predetermined construction is started on the construction site 2. The current terrain data creation unit 41 creates the current terrain data at the first frequency. The current terrain data created by the current terrain data creation unit 41 is stored in the storage unit 46. The current terrain data stored in the storage unit 46 is updated at the first frequency.

Note that the timing with which the detection device 12 detects the construction site 2 is not limited to the timing before starting the work of the day, and any timing may be employed.

The detection data acquisition unit 42 acquires the detection data from the detection device 9, the data being about each work machine 20 and a construction area around the work machine 20.

As described above, the detection device 9 detects part of the construction site 2. The part of the construction site 2 detected by the detection device 9 includes the work machine 20 that performs work. The part of the construction site 2 detected by the detection device 9 includes the construction area around the work machine 20 that performs work. An example of the construction area detected by the detection device 9 includes a construction area in which the work machine 20 is performing construction.

In the embodiment, the detection device 9 detects the construction site 2 at a second frequency higher than the first frequency. For example, the detection device 9 continuously detects the construction site 2 only for a certain period. For example, the detection device 9 continuously detects the construction site 2 only during a period in which the work of the work machine 20 is performed. Note that the detection device 9 may constantly detect the construction site 2. The detection data acquisition unit 42 acquires the detection data from the detection device 9 at the second frequency. The detection data acquired by the detection data acquisition unit 42 is updated more frequently than the current terrain data.

The recognition unit 43 recognizes the object on the construction site 2, on the basis of the detection data acquired by the detection data acquisition unit 42. As described above, the examples of the object include the work machine 20 and the person WM.

The recognition unit 43 recognizes the object by using artificial intelligence (AI) that analyzes the input data by an algorithm to output output data. The input data is the image data of the construction site 2 acquired by the detection device 9, and the output data is the object.

The recognition unit 43 holds a learning model generated by learning the features of the object. The learning model includes a learning model generated by learning the features of the work machine 20 and a learning model generated by learning the features of the person WM. In the generation of the learning model, machine learning is performed using a training image including the object as training data, thereby generating the learning model in which the features of the object are input and the object is output. The recognition unit 43 is configured to recognize the object by inputting the image data of the construction site 2 acquired by the detection device 9 to the learning model.

The reflection unit 44 generates reflection data in which the detection data acquired by the detection data acquisition unit 42 is reflected in the current terrain data. The current terrain data is the three-dimensional terrain data of the whole of the construction site 2 detected by the detection device 12 at the first frequency. The detection data includes three-dimensional terrain data of the construction area that is part of the construction site 2, detected by the detection device 9 at the second frequency. The detection data acquired by the detection data acquisition unit 42 is sequentially updated at the second frequency. The reflection unit 44 sequentially reflects the detection data acquired by the detection data acquisition unit 42, in part of the current terrain data at the second frequency. At least part of the current terrain data is sequentially updated with the detection data acquired by the detection data acquisition unit 42.

The detection data acquired by the detection data acquisition unit 42 includes updated terrain data that indicates an updated terrain of the construction area. The updated terrain includes the latest terrain during or after construction. The updated terrain data is updated at the second frequency. The reflection unit 44 reflects the updated terrain data acquired by the detection data acquisition unit 42, in the current terrain data stored in the storage unit 46.

The detection data acquired by the detection data acquisition unit 42 includes non-terrain data that indicates the object on the construction site 2. The non-terrain data is three-dimensional data that indicates the object being on the construction site 2. The non-terrain data is updated at the second frequency. The reflection unit 44 reflects the non-terrain data acquired by the detection data acquisition unit 42, in the current terrain data stored in the storage unit 46.

In the embodiment, the reflection unit 44 reflects the updated terrain data of the construction area in which the non-terrain data is removed from the detection data acquired by the detection data acquisition unit 42, in the current terrain data. The non-terrain data that indicates the object is recognized by the recognition unit 43. The reflection unit 44 removes the non-terrain data from the detection data to generate the updated terrain data. In addition, when the object is on the construction site 2, the reflection unit 44 generates the reflection data in which the object is reflected.

The reflection data generated by the reflection unit 44 includes updated terrain data of the construction area.

The reflection data generated by the reflection unit 44 includes the object recognized by the recognition unit 43.

The reflection data generated by the reflection unit 44 includes a three-dimensional model of the work machine 20 recognized by the recognition unit 43. The three-dimensional model of the work machine 20 includes computer graphics (CG) of the work machine 20.

The three-dimensional model of the work machine 20 is a three-dimensional model representing the work machine 20, and is constructed for each part constituting the work machines 20 such as the carriage 24, the swing body 25, and the working equipment 26. The three-dimensional model of the work machine 20 is stored in advance in the storage unit 46.

The reflection data generated by the reflection unit 44 includes a symbol image that indicates the position of the object. The symbol image is image data that emphasizes the position of the object. The reflection unit 44 generates the symbol image on the basis of a result of the recognition by the recognition unit 43.

The output unit 45 outputs the reflection data generated by the reflection unit 44 to the information terminal 5. The output unit 45 transmits the reflection data to the information terminal 5 via the communication system 10.

The information terminal 5 includes an input device 51 and a display device 52.

The input device 51 is operated by an administrator being at the remote place 13. The input device 51 generates input data on the basis of the operation of the administrator. An example of the input device 51 includes a touch screen, a computer keyboard, a mouse, or an operation button. Note that the input device 51 may be a non-contact input device including an optical sensor, or may be a voice input device.

The display device 52 displays display data. The administrator at the remote place 13 is allowed to confirm the display data displayed on the display device 52. In the embodiment, the output unit 45 outputs the reflection data generated by the reflection unit 44, to the display device 52. The display device 52 displays the reflection data generated by the reflection unit 44, as the display data. An example of the display device 52 includes a flat panel display such as a liquid crystal display (LCD) or an organic electroluminescence display (OELD).

[Relationship Between Detection Device and Three-Dimensional Data]

As described above, the position sensor 14 and the attitude sensor 15 are mounted on the flight vehicle 8. The position sensor 14 is configured to detect the position of the detection device 9. The attitude sensor 15 is configured to detect the attitude of the detection device 9. The attitude includes, for example, a roll angle, a pitch angle, and a yaw angle. The yaw angle may be calculated on the basis of detection data from two GNSS sensors provided in the flight vehicle 8. The detection device 9 detects the three-dimensional data of the construction site 2. The three-dimensional data of the construction site 2 includes a relative distance and a relative position between the detection device 9 and each of a plurality of detection points defined in the detection target. The recognition unit 43 and the reflection unit 44 are configured to calculate, for example, the position of the three-dimensional data of the detection target in the global coordinate system, on the basis of detection data from the position sensor 14, detection data from the attitude sensor 15, and the detection data from the detection device 9. In addition, the recognition unit 43 and the reflection unit 44 are each configured to perform a predetermined coordinate transformation to calculate, for example, the position of the three-dimensional data of the detection target in a local coordinate system defined for the construction site 2. The detection target to be detected by the detection device 9 includes the updated terrain and the object.

Likewise, the current terrain data creation unit 41 is configured to calculate, for example, the position of the three-dimensional data of the detection target in the local coordinate system defined for the construction site 2, on the basis of detection data from the position sensor 16, detection data from the attitude sensor 17, and the detection data from the detection device 12. The detection target to be detected by the detection device 12 includes the current terrain.

The recognition unit 43 is configured to recognize the presence or absence of the object and the position of the object, on the basis of the detection data acquired by the detection data acquisition unit 42. For example, when recognizing the position of the person WM, the recognition unit 43 recognizes the person WM on the basis of two-dimensional image acquired by the monocular camera of the detection device 9. In addition, the recognition unit 43 acquires the three-dimensional terrain data of the construction site 2. The recognition unit 43 is configured to recognize the position of the person WM on the construction site 2, on the basis of the person WM recognized on the basis of the two-dimensional image. For example, the position of the person WM on the construction site 2 is recognizable by performing image processing, on the person WM recognized on the basis of the two-dimensional images acquired by the two monocular cameras constituting the stereo camera, on the basis of the principle of triangulation, calculating the three-dimensional position of the person WM so as to correspond to the three-dimensional terrain data of the construction site 2. In addition, the position of the person WM on the construction site 2 may be recognized by calculating the three-dimensional position of the person WM recognized on the basis of the two-dimensional image by using a detection value of the laser sensor or radar sensor so as to correspond to the three-dimensional terrain data of the construction site 2. Note that the recognition unit 43 may recognize the position of the person WM from the three-dimensional data of the construction site 2. Note that the recognition unit 43 may recognize the position of the person WM on the basis of detection data from a position sensor held by the person WM. For example, if the person WM holds a smartphone and a GNSS sensor is mounted on the smartphone, the recognition unit 43 is allowed to recognize the position of the person WM on the basis of detection data from the GNSS sensor of the smartphone. Note that the position sensor held by the person WM may use a beacon. Note that the position of the person WM on the construction site 2 may be estimated by geometric calculation, on the basis of coordinates, on the two-dimensional image, of the person WM recognized on the basis of the two-dimensional image, a three-dimensional position and attitude of the detection device 9, and the three-dimensional terrain data.

In addition, the recognition unit 43 is configured to recognize the movements of the work machines 20, on the basis of the detection data acquired by the detection data acquisition unit 42. The excavator 21 is configured to operate the carriage 24, the swing body 25, and the working equipment 26. The crawler carrier 23 is configured to operate the carriage 28 and the dump body 30. The reflection unit 44 is configured to move the three-dimensional model in synchronization with each of the work machines 20.

[Construction Management Method]

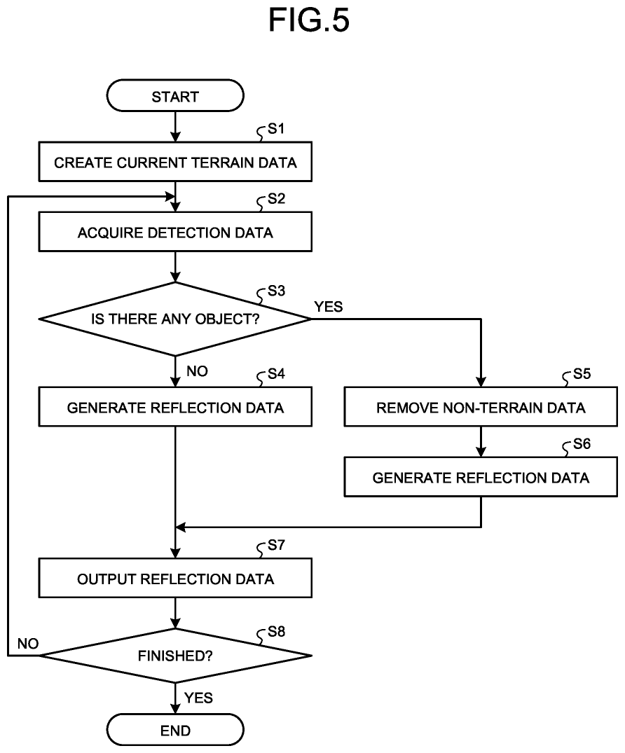

FIG. 5 is a flowchart illustrating a construction management method according to an embodiment. The current terrain data creation unit 41 creates the current terrain data of the construction site 2 on which the work machine 20 performs an operation (Step S1).

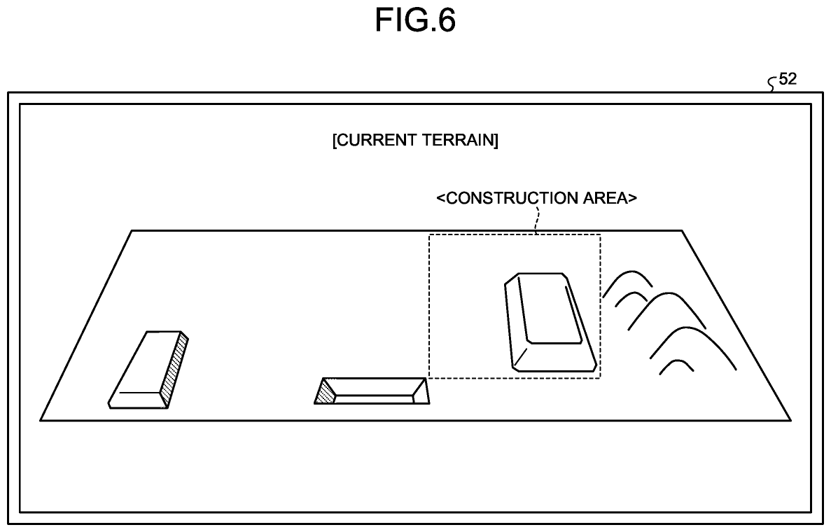

FIG. 6 is a diagram illustrating the current terrain data according to the embodiment. The current terrain data is the three-dimensional terrain data that indicates the current terrain of the whole of the construction site 2. The current terrain data creation unit 41 acquires the detection data from the detection device 12. The current terrain data creation unit 41 creates the current terrain data on the basis of the detection data from the detection device 12.

The current terrain data created by the current terrain data creation unit 41 is stored in the storage unit 46. The output unit 45 is configured to transmit the current terrain data to the information terminal 5. The display device 52 is configured to display the current terrain as illustrated in FIG. 6.

When work of the work machine 20 is started on the construction site 2, the terrain of the construction site 2 changes. The detection device 9 mounted on the flight vehicle 8 detects the construction site 2. The detection device 9 detects, for example, the work machine 20 performing work and the construction area around the work machine 20. Detection data from the detection device 9 is transmitted to the management device 3 via the cable 7. The management device 3 transmits the detection data from the detection device 9 to the server 4. The detection data acquisition unit 42 acquires the detection data from the detection device 9, the data being obtained by detecting the work machine 20 and the construction area around the work machine 20 (Step S2).

The recognition unit 43 determines whether the object is on the construction site 2, on the basis of the detection data acquired by the detection data acquisition unit 42. In the embodiment, the recognition unit 43 determines whether the object is in the construction area (Step S3).

In Step S3, when it is determined that no object is in the construction area (Step S3: No), the reflection unit 44 reflects the detection data acquired by the detection data acquisition unit 42 in the current terrain data stored in the storage unit 46 to generate the reflection data. The detection data acquired by the detection data acquisition unit 42 includes updated terrain data of the construction area that is part of the construction site 2. The reflection unit 44 reflects the updated terrain data in the current terrain data (Step S4).

For example, when part of the construction site 2 is excavated by the excavator 21, the detection data including an excavated position is acquired by the detection data acquisition unit 42, as the updated terrain data. The updated terrain data includes the excavated position excavated by the excavator 21. The reflection unit 44 combines part of the current terrain data and the updated terrain data. The reflection unit 44 applies the updated terrain data to the part of the current terrain data. Therefore, the reflection data in which the updated terrain data including the excavated position is reflected is generated.

In Step S3, when it is determined that the object is in the construction area (Step S3: Yes), the reflection unit 44 removes the non-terrain data that indicates the object recognized by the recognition unit 43, from the detection data to generate the updated terrain data (Step S5).

After the updated terrain data is generated, the reflection unit 44 reflects the updated terrain data in the current terrain data to generate the reflection data. Furthermore, upon presence of the object, the reflection unit 44 generates the reflection data in which the object is reflected (Step S6).

Note that, even upon the presence of the object, the reflection unit 44 may generate the reflection data in which the object is not reflected.

The output unit 45 outputs the reflection data generated in at least one of Step S4 and Step S6, to the information terminal 5. The display device 52 displays the reflection data transmitted from the output unit 45 (Step S7).

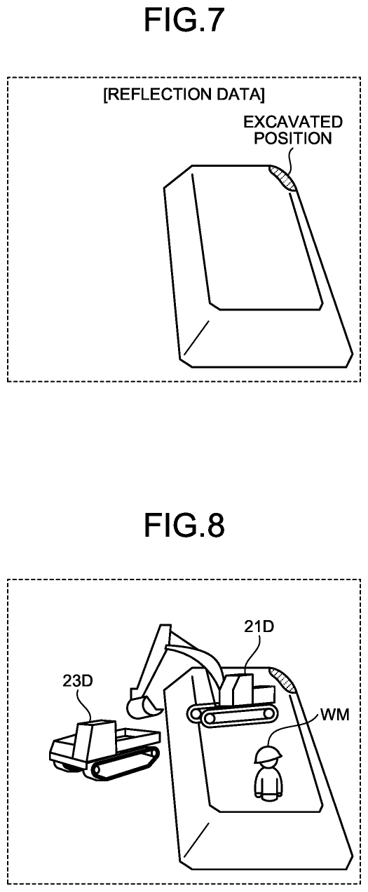

FIG. 7 is a diagram illustrating the reflection data according to an embodiment. FIG. 7 illustrates the reflection data where no object is in the construction area. The reflection data includes image data of the construction area. For example, with the progress of construction in the construction area, at least part of the terrain of the construction site 2 changes as illustrated in FIG. 7. In the example illustrated in FIG. 7, the excavated position is generated in the construction area by the excavation work of the excavator 21. The detection data acquired by the detection data acquisition unit 42 includes the updated terrain data of the construction area. The reflection unit 44 reflects the change of the terrain of the construction site 2 in the current terrain, in real time. The reflection unit 44 reflects the updated terrain data in the current terrain data, in real time. As illustrated in FIG. 7, the display device 52 is configured to display the reflection data in which the excavated position is reflected. The administrator at the remote place 13 is allowed to confirm the reflection data displayed on the display device 52 to recognize the progress of the construction on the construction site 2 in real time.

FIG. 8 is a diagram illustrating the reflection data according to an embodiment. FIG. 8 illustrates the reflection data where the excavator 21, the crawler carrier 23, and the person WM are in the construction area, as the objects. The reflection data includes the three-dimensional terrain data in which the updated terrain data is reflected in part of the current terrain data. The reflection data includes the three-dimensional model of the work machine 20 recognized by the recognition unit 43. In the example illustrated in FIG. 8, the three-dimensional models of the work machines 20 include a three-dimensional model 21D of the excavator 21 and a three-dimensional model 23D of the crawler carrier 23.

In displaying a three-dimensional model of each work machine 20 on the display device 52, the recognition unit 43 calculates the position (three-dimensional position) and attitude of the work machine 20, on the basis of the detection data from the detection device 12, acquired by the detection data acquisition unit 42. The attitude of the work machine 20 includes inclination of the swing body 25 relative to a horizontal plane and a turning angle of the swing body 25 relative to the carriage 24. Furthermore, the attitude of the work machine 20 includes an angle of the working equipment 26. The angle of the working equipment 26 includes an angle of the boom 26A, an angle of the arm 26B, and an angle of the bucket 26C. The detection data from the detection device 12 includes an image acquired by a stereo camera. Therefore, the recognition unit 43 is configured to calculate the three-dimensional position and attitude of the work machine 20, on the basis of the detection data from the detection device 12. The reflection unit 44 adjusts the three-dimensional model so that the three-dimensional model stored in the storage unit 46 is arranged at the position calculated by the recognition unit 43 and is in the attitude calculated by the recognition unit 43, generating the reflection data.

As described above, the three-dimensional model of the work machine 20 is constructed for each part constituting the work machines 20 such as the carriage 24, the swing body 25, and the working equipment 26. The reflection unit 44 changes the angle of a corresponding portion of the three-dimensional model on the basis of the angle of the boom 26A, the angle of the arm 26B, the angle of the bucket 26C, and the turning angle of the swing body 25, adjusting the three-dimensional model.

The output unit 45 outputs the reflection data including the three-dimensional model generated by the reflection unit 44, to the display device 52.

Note that in a case where two GNSS sensors are mounted on the swing body 25 of the work machine 20, the recognition unit 43 may calculate the position of the work machine 20 on the basis of detection data from one GNSS sensor. Furthermore, the recognition unit 43 may calculate the inclination and turning angle of the swing body 25 on the basis of the detection data from each of the two GNSS sensors. In a case where a stroke sensor is provided in each of the boom cylinder 27A, the arm cylinder 27B, and the bucket cylinder 27C, the recognition unit 43 may calculate the angle of the working equipment 26 on the basis of detection data from each stroke sensor.

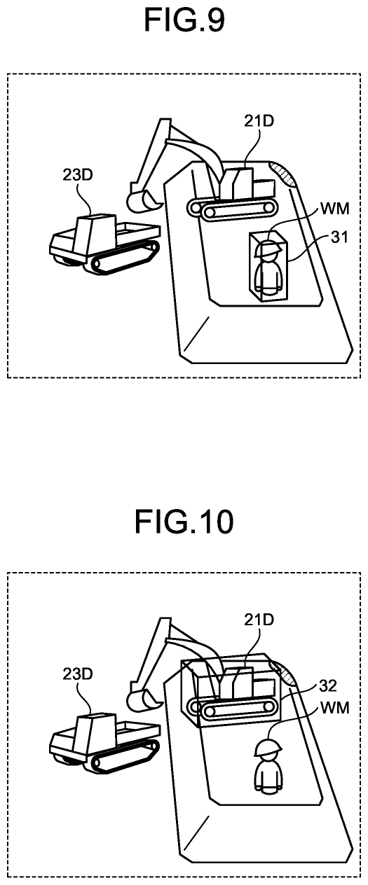

FIG. 9 is a diagram illustrating the reflection data according to an embodiment. The reflection data includes the symbol image that indicates the position of the object. In the example illustrated in FIG. 9, the reflection data includes a symbol image 31 that indicates the position of the person WM. The reflection unit 44 generates the symbol image 31 on the basis of the position of the person WM recognized by the recognition unit 43. The reflection unit 44 generates the reflection data so that the person WM and the symbol image 31 are displayed in a superimposed manner. In the example illustrated in FIG. 9, the symbol image 31 has a frame shape (box shape) surrounding the person WM. Note that the symbol image 31 may have any shape as long as the person WM is emphasized. Note that the symbol image 31 may be displayed adjacent to the person WM. Emphasizing the person WM with the symbol image 31 allows the administrator at the remote place 13 to smoothly recognize the presence of the person WM.

FIG. 10 is a diagram illustrating the reflection data according to an embodiment. In the example illustrated in FIG. 10, the reflection data includes a symbol image 32 that indicates the position of the excavator 21. The reflection unit 44 is configured to generate the symbol image 32 on the basis of the position of the excavator 21 recognized by the recognition unit 43. In the example illustrated in FIG. 10, the symbol image 32 has a frame shape (box shape) surrounding the three-dimensional model 21D. The reflection unit 44 generates the reflection data so that the three-dimensional model 21D of the excavator 21 and the symbol image 32 are displayed in a superimposed manner. Note that the symbol image 32 may have any shape as long as the excavator 21 is emphasized.

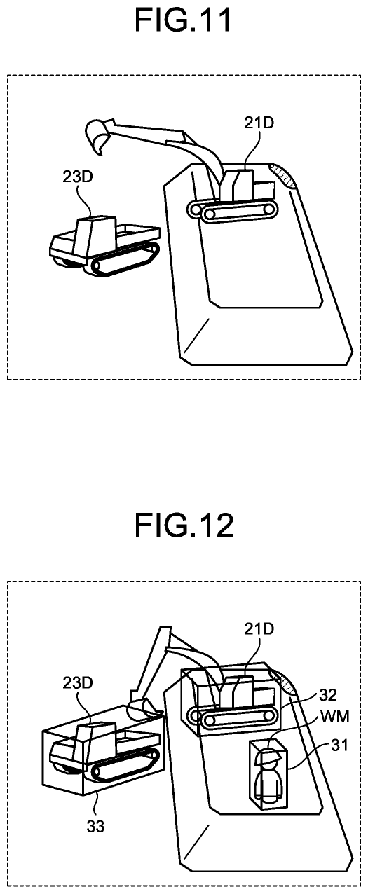

FIG. 11 is a diagram illustrating the reflection data according to an embodiment. In the example illustrated in FIG. 11, the reflection data includes the three-dimensional model 21D that moves in synchronization with the excavator 21. As described above, the recognition unit 43 is configured to recognize the movement of the work machine 20. The reflection unit 44 is configured to move the three-dimensional model 21D on the display device 52 in synchronization with the movement of the excavator 21 on the basis of the movement of the excavator 21 recognized by the recognition unit 43. FIG. 11 illustrates an example of a rising movement of a boom of the three-dimensional model 21D in synchronization with the rising movement of the boom 26A of the excavator 21. Likewise, the reflection unit 44 is configured to move the three-dimensional model 23D on the display device 52 so as to be synchronized with the movement of the crawler carrier 23, on the basis of the movement of the crawler carrier 23 recognized by the recognition unit 43.

FIG. 12 is a diagram illustrating the reflection data according to an embodiment. In the example illustrated in FIG. 12, the reflection data includes the symbol image 31 that indicates the position of the person WM, the symbol image 32 that indicates the position of the excavator 21, and a symbol image 33 that indicates the position of the crawler carrier 23. The reflection unit 44 generates the reflection data so that, for example, the three-dimensional model 23D of the crawler carrier 23 and the symbol image 33 are displayed in a superimposed manner.

The reflection unit 44 determines whether construction in the construction area is finished (Step S8).

When it is determined that construction is not finished in Step S8 (Step S8: No), the processing from Step S2 to Step S7 is repeated. When it is determined that construction is finished in Step S8 (Step S8: Yes), the construction management method according to the embodiment is finished.

[Computer System]

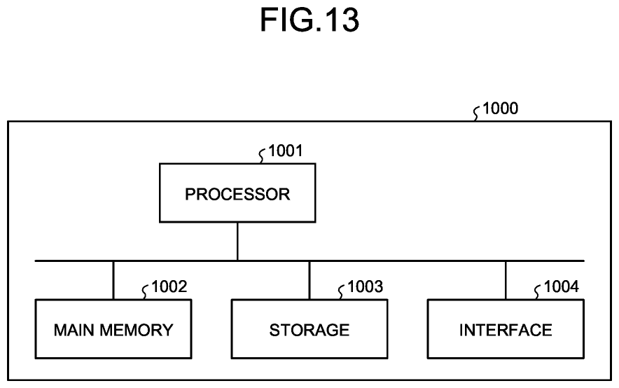

FIG. 13 is a block diagram illustrating a computer system 1000 according to the embodiment. The server 4 described above includes the computer system 1000. The computer system 1000 includes a processor 1001 such as a central processing unit (CPU), a main memory 1002 that includes a nonvolatile memory such as a read only memory (ROM) and a volatile memory such as a random access memory (RAM), a storage 1003, and an interface 1004 that includes an input/output circuit. The functions of the server 4 described above are stored, as computer programs, in the storage 1003. The processor 1001 reads the computer programs from the storage 1003, loads the programs into the main memory 1002, and executes processing described above according to the computer programs. Note that the computer programs may be distributed to the computer system 1000 via a network.

According to the embodiments described above, the computer programs or the computer system 1000 is configured to execute storing the current terrain data of the construction site 2 on which the work machine 20 operates, acquiring the detection data from the detection device 9 that detects the construction site 2, generating the reflection data in which the detection data is reflected in the current terrain data, and displaying the reflection data on the display device 52.

[Effects]

As described above, according to the embodiments, the current terrain data that indicates the reference terrain of the construction site 2 before construction is created. During construction, the work machine 20 and the construction area around the work machine 20 are detected by the detection device 9. The reflection data in which the detection data is reflected in the current terrain data is displayed on the display device 52. The administrator at the remote place 13 is allowed to confirm the display device 52 to confirm the progress of construction in the construction area in real time. The administrator at the remote place 13 is allowed to remotely monitor the progress of the construction.

The detection data reflected in the current terrain data is updated more frequently than the current terrain data. Therefore, the administrator at the remote place 13 is allowed to check the latest situation of the construction area.

The detection data reflected in the current terrain data includes the updated terrain data of the construction area. Therefore, the administrator at the remote place 13 is allowed to confirm the latest terrain of the construction area during or after construction.

The detection data reflected in the current terrain data includes the non-terrain data that indicates the object on the construction site 2. The reflection unit 44 reflects the updated terrain data in which the non-terrain data is removed from the detection data acquired by the detection data acquisition unit 42, in the current terrain data. Therefore, the administrator at the remote place 13 is allowed to confirm the latest terrain of the construction area in which the influence of the object is suppressed.

The detection data reflected in the current terrain data includes the non-terrain data that indicates the object on the construction site 2. Therefore, the administrator at the remote place 13 is allowed to confirm not only the latest terrain of the construction site but also the situation of the object on the construction site 2 in real time.

The reflection data displayed on the display device 52 includes the object recognized by the recognition unit 43. The display device 52 displays the reflection data in which the latest terrain and the object are distinguished from each other. Therefore, the administrator at the remote place 13 is allowed to appropriately confirm both of the latest terrain of the construction site and the situation of the object on the construction site 2, in real time.

The reflection data displayed on the display device 52 includes the three-dimensional model of each work machine 20. The administrator at the remote place 13 is allowed to confirm the three-dimensional model displayed on the display device 52 to appropriately confirm a situation of the work machine 20 in real time.

The recognition unit 43 recognizes the movement of the work machine 20, on the basis of the detection data acquired by the detection data acquisition unit 42. The reflection unit 44 is configured to move the three-dimensional model in synchronization with the work machine 20, on the basis of a result of the recognition by the recognition unit 43. The administrator at the remote place 13 is allowed to confirm the three-dimensional model that moves in synchronization with the actual work machine 20 to appropriately confirm the situation of the work machine 20 in real time.

The recognition unit 43 recognizes the person WM, on the basis of the detection data acquired by the detection data acquisition unit 42. The administrator at the remote place 13 is allowed to confirm the person WM displayed on the display device 52 to appropriately confirm the situation of the person WM in real time.

The reflection data displayed on the display device 52 includes the symbol image that indicates the position of the object. The administrator at the remote place 13 is allowed to confirm the symbol image displayed on the display device 52 to appropriately confirm the position of the object.

The detection device 9 is mounted on a flight vehicle 8. This configuration makes it possible for the detection device 9 to collectively detect the work machines 20 and the construction area from above.

### Other Embodiments

In the embodiments described above, the recognition unit 43 recognizes the position of the work machine 20 on the basis of the detection data from the detection device 9. For example, a position sensor that detects the position of the work machine 20 may be provided at the work machine 20 so that the recognition unit 43 may recognize the position of the work machine 20 on the basis of detection data from the position sensor.

In the embodiments described above, the recognition unit 43 recognizes the movement of the work machine 20 on the basis of the detection data from the detection device 9. For example, a motion sensor that detects the movement of the work machine 20 may be provided at the work machine 20 so that the recognition unit 43 may recognize the movement of the work machine 20 on the basis of detection data from the motion sensor. An example of the motion sensor includes, for example, an angle sensor that detects the motion of the working equipment 26 or a stroke sensor that detects the expansion/contraction amount of the hydraulic cylinder 27.

In the embodiments described above, the recognition unit 43 may recognize the object on the basis of, for example, a pattern matching method without using the artificial intelligence. The recognition unit 43 is configured to recognize the object by collating a template that indicates the person WM with the image data of the construction site 2.

In the embodiments described above, the detection device 9 may not be mounted on the flight vehicle 8. The detection device 9 may be mounted on, for example, the work machine 20 or may be mounted to a structure on the construction site 2. The same applies to the detection device 12.

In the embodiments described above, each of the current terrain data creation unit 41, the detection data acquisition unit 42, the recognition unit 43, the reflection unit 44, the output unit 45, and the storage unit 46 may be constituted by different pieces of hardware. For example, at least one of the function of the current terrain data creation unit 41, the function of the detection data acquisition unit 42, the function of the recognition unit 43, the function of the reflection unit 44, the function of the output unit 45, and the function of the storage unit 46 may be provided in the management device 3, or may be provided in a server different from the server 4.

In the embodiments described above, the management device 3 is supported by the carrier 6 and is configured to travel on the construction site 2. The management device 3 may be mounted on each work machine 20 or may be installed at a predetermined position on the construction site 2.

In the embodiments described above, the detection device 12 detects the whole of the construction site 2, and the detection device 9 detects part of the construction site 2. The detection device 9 may detect the whole of the construction site 2.

In the embodiments described above, the detection target to be detected by the detection device 9 is not limited to the terrain of the construction site 2, the work machine 20, and the person WM. In another embodiment, the detection device 9 may detect the construction material.

In the embodiments described above, the information terminal 5 may not be arranged at the remote place 13 from the construction site 2. The information terminal 5 may be mounted, for example, on the work machine 20. Furthermore, the information terminal 5 may be omitted. The progress of construction may be output to the work machine 20 from the monitor. The monitor may include not only a display device but also an input device.

In the embodiments described above, the work machine 20 is not limited to the configuration including the excavator 21, the bulldozer 22, and the crawler carrier 23. In another embodiment, the work machine 20 may include some of the excavator 21, the bulldozer 22, and the crawler carrier 23. In addition, the work machine 20 may include another type of work machine.

The embodiments described above are not limited to the configuration in which the position of the flight vehicle 8 is detected by using the global navigation satellite system (GNSS) and the attitude of the flight vehicle 8 is detected by using the inertial measurement unit. In another embodiment, the position and attitude of the flight vehicle 8 may be detected by using simultaneous localization and mapping (SLAM). Likewise, the positions and attitudes of the flight vehicle 11 and the work machines 20 may be detected by using SLAM.

### REFERENCE SIGNS LIST

1 CONSTRUCTION MANAGEMENT SYSTEM
2 CONSTRUCTION SITE
3 MANAGEMENT DEVICE
4 SERVER (DATA PROCESSING DEVICE)
5 INFORMATION TERMINAL
6 CARRIER
7 CABLE
8 FLIGHT VEHICLE
9 DETECTION DEVICE
10 COMMUNICATION SYSTEM
11 FLIGHT VEHICLE
12 DETECTION DEVICE
13 REMOTE PLACE
14 POSITION SENSOR
15 ATTITUDE SENSOR
16 POSITION SENSOR
17 ATTITUDE SENSOR
20 WORK MACHINE
21 EXCAVATOR
21D THREE-DIMENSIONAL MODEL
22 BULLDOZER
23 CRAWLER CARRIER
23D THREE-DIMENSIONAL MODEL
24 CARRIAGE
25 SWING BODY
26 WORKING EQUIPMENT
26A BOOM
26B ARM
26C BUCKET
27 HYDRAULIC CYLINDER
27A BOOM CYLINDER
27B ARM CYLINDER
27C BUCKET CYLINDER
28 CARRIAGE
29 VEHICLE BODY
30 DUMP BODY
31 SYMBOL IMAGE
32 SYMBOL IMAGE
33 SYMBOL IMAGE
41 CURRENT TERRAIN DATA CREATION UNIT
42 DETECTION DATA ACQUISITION UNIT
43 RECOGNITION UNIT
44 REFLECTION UNIT
45 OUTPUT UNIT
46 STORAGE UNIT
51 INPUT DEVICE
52 DISPLAY DEVICE
1000 COMPUTER SYSTEM
1001 PROCESSOR
1002 MAIN MEMORY
1003 STORAGE
1004 INTERFACE
WM PERSON

1. A construction management system comprising:
a current terrain data creation unit that creates current terrain data of a construction site on which a work machine operates;
a detection data acquisition unit that acquires detection data of a detection device that detects the construction site;
a reflection unit that generates reflection data in which the detection data is reflected in the current terrain data; and
an output unit that outputs the reflection data on a display device.

2. The construction management system according to claim 1, wherein
the detection data is updated more frequently than the current terrain data.

3. The construction management system according to claim 1, wherein
the detection data includes updated terrain data of the construction site.

4. The construction management system according to claim 1, wherein
the detection data includes non-terrain data that indicates an object on the construction site, and
the reflection unit reflects updated terrain data of the construction site in which the non-terrain data is removed from the detection data, in the current terrain data.

5. The construction management system according to claim 1, wherein
the detection data includes non-terrain data that indicates an object on the construction site.

6. The construction management system according to claim 1, comprising
a recognition unit that recognizes an object on the construction site based on the detection data,
wherein the reflection data includes the object recognized by the recognition unit.

7. The construction management system according to claim 6, wherein
the object includes the work machine, and
the reflection data includes a three-dimensional model of the work machine.

8. The construction management system according to claim 7, wherein
the recognition unit recognizes movement of the work machine, and
the reflection unit moves the three-dimensional model in synchronization with the work machine.

9. The construction management system according to claim 6, wherein
the object includes a person.

10. The construction management system according to claim 6, wherein
the recognition unit recognizes a position of the object, and
the reflection data includes a symbol image that indicates the position of the object.

11. The construction management system according to claim 1, wherein
the detection device is mounted on a flight vehicle.

12. The construction management system according to claim 1, wherein
the detection device detects the work machine and a construction area around the work machine.

13. A data processing device comprising:
a current terrain data creation unit that creates current terrain data of a construction site on which a work machine operates;
a detection data acquisition unit that acquires detection data of a detection device that detects the construction site;
a reflection unit that generates reflection data in which the detection data is reflected in the current terrain data; and
an output unit that outputs the reflection data on a display device.

14. A construction management method comprising:
storing current terrain data of a construction site on which a work machine operates;
acquiring detection data of a detection device that detects the construction site;
generating reflection data in which the detection data is reflected in the current terrain data; and
displaying the reflection data on a display device.

15. The construction management method according to claim 14, wherein
the detection data is updated more frequently than the current terrain data.

16. The construction management method according to claim 14 or 15, wherein
the detection data includes updated terrain data of the construction site.

17. The construction management method according to claim 14 or 15, wherein
the detection data includes non-terrain data that indicates an object on the construction site, and
updated terrain data of the construction site in which the non-terrain data is removed from the detection data is reflected in the current terrain data.

18. The construction management method according to claim 14 or 15, wherein
the detection data includes non-terrain data that indicates an object on the construction site.

19. The construction management method according to claim 14 or 15, comprising
recognizing an object on the construction site based on the detection data,
wherein the reflection data includes the object recognized.

20. The construction management method according to claim 19, wherein
the object includes the work machine, and
the reflection data includes a three-dimensional model of the work machine.
